(19) United States
(12) Patent Application Publication
(10) Pub. No.: US 2026/0021591 A1
(43) Pub. Date: Jan. 22, 2026

(54) GRASP DEVICE

(71) Applicant: InnoLux Corporation, Miao-Li County (TW)

(72) Inventors: Huang-Ren YAO, Miao-Li County (TW); Ming-Han LIN, Miao-Li County (TW)

(21) Appl. No.: 19/241,522

(22) Filed: Jun. 18, 2025

Related U.S. Application Data
(60) Provisional application No. 63/672,887, filed on Jul. 18, 2024.

(30) Foreign Application Priority Data
Dec. 26, 2024 (CN) 202411934352.4

(51) Int. Cl. B25J 15/00

(52) U.S. Cl. CPC B25J 15/0033

(57) ABSTRACT

A grasp device is used to grasp a container, and includes a main body, a first structure member and a moving member. The first structure member is fixed to the main body. The moving member is disposed on the main body. The first structure member and the moving member are used to contact a portion of the container. There is a first space between the moving member and the first structure member when the moving member is disposed at a first position. There is a second space between the moving member and the first structure member when the moving member is disposed at a second position, where a size of the second space is larger than a size of the first space.

### CROSS-REFERENCE TO RELATED APPLICATIONS

This application claims the benefit of filing date of U.S. Provisional Application Ser. No. 63/672,887 filed on Jul. 18, 2024 under 35 USC § 119(e)(1), and also claims the benefit of the Chinese Patent Application Serial Number 202411934352.4, filed on Dec. 26, 2024, the subject matters of which are incorporated herein by reference.

### BACKGROUND

### Field of the Application

The present application relates to a grasp device and, more particularly, to a grasp device that can grasp containers of different sizes.

### Description of Related Art

In current automated equipment, although machines (such as robotic arms) may be used to clamp or fix the bottle neck of containers (such as medicine bottles) to move or transport containers, due to that the sources or types of containers are diverse and complicated, it is difficult to use the same machine to fit containers of different sizes, or the machine must be designed and/or controlled with high precision to grasp containers of different sizes with little or no damage. However, high-precision design and/or control means that the machine itself is highly complicated, which will result in increased manufacturing costs and/or operating costs.

Therefore, there is a need to provide an improved grasp device so as to alleviate and/or obviate the above problems.

### SUMMARY

The present application provides a grasp device for grasping a container. The grasp device includes a main body, a first structure member and a moving member. The first structure member is fixed to the main body. The moving member is disposed on the main body. The first structure member and the moving member are used to contact a portion of the container, wherein there is a first space between the moving member and the first structure member when the moving member is disposed at a first position, and there is a second space between the moving member and the first structure member when the moving member is disposed at a second position, where a size of the second space is larger than a size of the first space.

Other novel features of the application will become more apparent from the following detailed description when taken in conjunction with the accompanying drawings.

### BRIEF DESCRIPTION OF DRAWINGS

FIG. 1 is an exploded view of a grasp device according to an embodiment of the present application;

FIG. 2A is a flow chart showing the steps of the operation process of a drug preparation device according to an embodiment of the present application;

FIG. 2B is a flow chart showing the steps of the operation process of a drug preparation device according to another embodiment of the present application;

FIG. 3 is a flow chart showing the steps of clamping or fixing a container by a grasp device according to an embodiment of the present application;

FIG. 4A is a schematic diagram of a first structure member according to an embodiment of the present application at one viewing angle;

FIG. 4B is a schematic diagram of a first structure member according to an embodiment of the present application at another viewing angle;

FIG. 5 is a schematic diagram of a moving member according to an embodiment of the present application;

FIG. 6A is a schematic diagram of a first state of the grasp device according to an embodiment of the present application;

FIG. 6B is a schematic diagram of a second state of the grasp device according to an embodiment of the present application;

FIG. 7A is a schematic diagram of a third state of the grasp device according to an embodiment of the present application;

FIG. 7B is a cross-sectional view of the grasp device taken along line AA′ in FIG. 7A;

FIG. 7C is a cross-sectional view of the grasp device taken along line CC′ in FIG. 7B; and

FIG. 8 is a schematic diagram of the third state of the grasp device according to an embodiment of the present application at another viewing angle.

### DETAILED DESCRIPTION OF EMBODIMENT

Reference will now be made in detail to exemplary embodiments of the present application, examples of which are illustrated in the accompanying drawings. Wherever possible, the same reference numerals are used in the drawings and description to refer to the same or like parts.

Throughout the specification and the appended claims, certain terms may be used to refer to specific components. Those skilled in the art will understand that electronic device manufacturers may refer to the same components by different names. The present disclosure does not intend to distinguish between components that have the same function but have different names. In the following description and claims, words such as “containing” and “comprising” are open-ended words, and should be interpreted as meaning “including but not limited to”.

The terms, such as “about”, “substantially”, or “approximately” are generally interpreted as within 10% of a given value or range, or as within 5%, 3%, 2%, 1% or 0.5% of a given value or range.

In the specification and claims, unless otherwise specified, ordinal numbers, such as “first” and “second”, used herein are intended to distinguish components rather than disclose explicitly or implicitly that names of the components bear the wording of the ordinal numbers. The ordinal numbers do not imply what order a component and another component are in terms of space, time or steps of a manufacturing method. Thus, what is referred to as a “first component” in the specification may be referred to as a “second component” in the claims.

In the present application, the terms “the given range is from the first numerical value to the second numerical value” and “the given range falls within the range from the first numerical value to the second numerical value” mean that the given range includes the first numerical value, the second numerical value, and other values between the first numerical value and the second numerical value.

In addition, the grasp device disclosed in the present application may be applied to the electronic device itself, the application of the electronic device or the process of the electronic device. The electronic device may include an automation device, a mechanical device, a drug preparation device, an exposure device, a printing device, a three-dimensional printing device, a vehicle device, an imaging device, an assembly device, a backlight device, an antenna device, a tiled device, a touch electronic device, a curved electronic device or a free shape electronic device, but not limited thereto. The display device may include, for example, liquid crystal, light emitting diode, fluorescence, phosphor, other suitable display media, or a combination thereof, but not limited thereto. The display device may be a non-self-luminous display device or a self-luminous display device. The antenna device may be a liquid crystal type antenna device or a non-liquid crystal type antenna device, and the sensing device may be a sensing device that senses capacitance, light, heat energy, or ultrasound, but not limited thereto. The tiled device may include, for example, a display tiled device or an antenna tiled device, but not limited thereto. It should be noted that the electronic device may be any arrangement or combination of the aforementioned, but not limited thereto. In addition, the electronic device may be a bendable or flexible electronic device. It should be noted that the electronic device may be any arrangement or combination of the aforementioned, but not limited thereto. In addition, the shape of the electronic device may be rectangular, circular, polygonal, a shape with curved edges, or other suitable shapes. The electronic device may have a peripheral system, such as a driving system, a control system, a light source system, a shelf system, etc. so as to support a display device, an antenna device, or a tiled device.

It is noted that the following are exemplary embodiments of the present application, but the present disclosure is not limited thereto, while a feature of some embodiments can be applied to other embodiments through suitable modification, substitution, combination, or separation. In addition, the present disclosure can be combined with other known structures to form further embodiments.

Unless otherwise defined, all terms (including technical and scientific terms) used herein have the same meaning as commonly understood by those skilled in the art related to the present application. It can be understood that these terms, such as those defined in commonly used dictionaries, should be interpreted as having meaning consistent with the relevant technology and the background or context of the present disclosure, and should not be interpreted in an idealized or excessively formal way, unless there is a special definition in the embodiment of the present application.

In addition, the term “adjacent” in the specification and claims is used to describe mutual proximity, and does not necessarily mean mutual contact.

In addition, descriptions such as “when” or “while” in the present application represent aspects such as “now, before or after”, and are not limited to situations that occur at the same time. In the present application, similar descriptions such as “disposed on” refer to the corresponding positional relationship between the two components, and do not limit whether there is contact between the two components, unless otherwise specified. Furthermore, when the present disclosure provides multiple functions, if the word “or” is used between the functions, it means that the functions may exist independently, but it does not exclude that multiple functions may exist simultaneously.

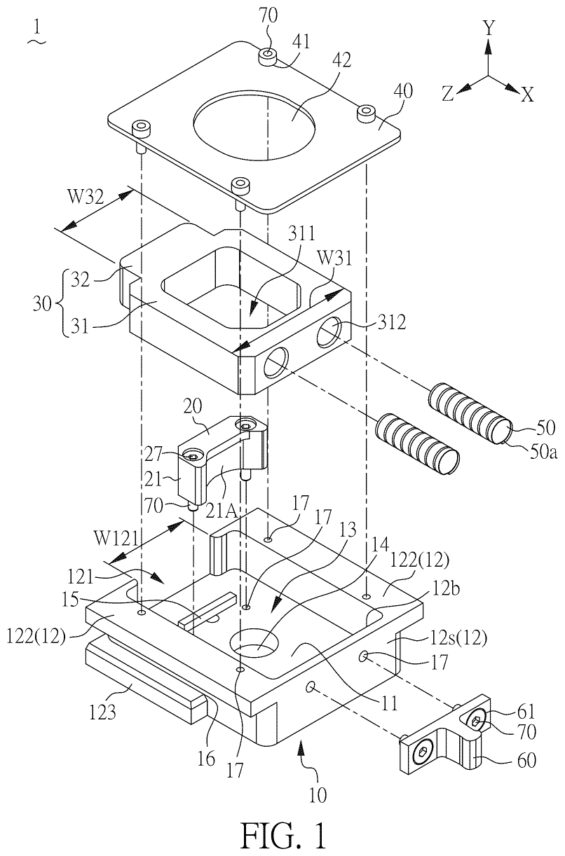

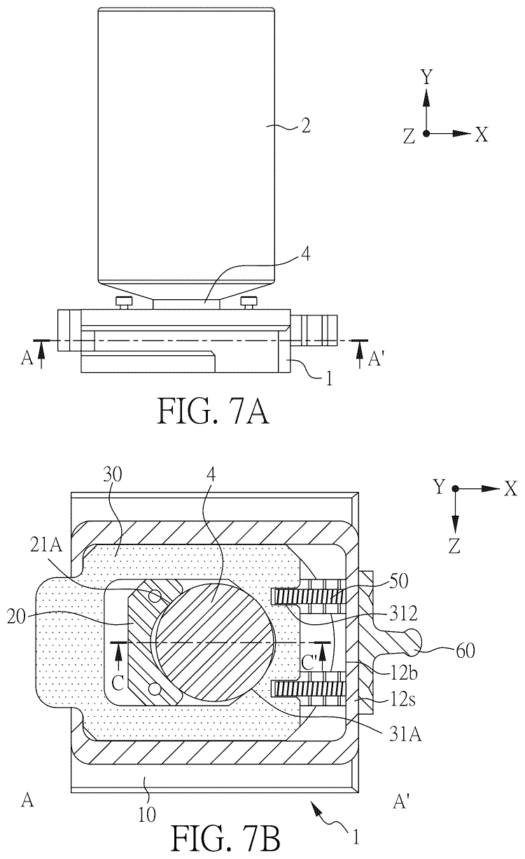

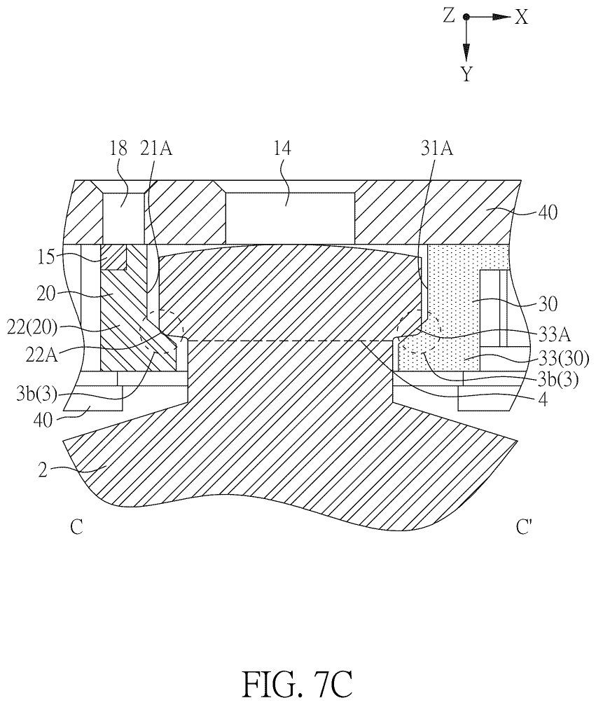

FIG. 1 is an exploded view of a grasp device 1 according to an embodiment of the present application, wherein the grasp device 1 may be used to grasp a container 2 (shown in FIG. 6A) and may be assembled in an electronic device. As shown in FIG. 1, the grasp device 1 at least includes a main body 10, a first structure member 20 and a moving member 30. The first structure member 20 may be fixed on the main body 10. The moving member 30 may be disposed on the main body 10, wherein the first structure member 20 and the moving member 30 are used to contact a portion of the container 2 (shown in FIG. 7A to FIG. 7C, which will be described in subsequent paragraphs).

In one embodiment, the grasp device 1 may further include a cover plate 40, which may be disposed on the main body 10, the first structure member 20 and the moving member 30. For example, the cover plate 40 may be fixed on the main body 10, and a accommodation space 13 is formed between the cover plate 40 and the main body 10. The cover plate 40 may cover at least a portion of the first structure member 20 and/or the moving member 30, or at least a portion of the first structure member 20 and/or the moving member 30 may be disposed in the accommodation space 13, while it is not limited thereto. In one embodiment, the grasp device 1 may further include at least one spring 50, wherein a portion of the at least one spring 50 may be disposed in the moving member 30, and the other portion of the at least one spring 50 may be exposed outside the moving member 30, and the other portion of the at least one spring 50 may contact the main body 10 when the moving member 30 is disposed on the main body 10, while it is not limited thereto. In one embodiment, the grasp device 1 may further include an engaging member 60 fixed on the main body 10.

The grasp device 1 of the present application may be used to clamp or fix containers 2 of different sizes. The following is an example of the grasp device 1 applied to an electronic device, especially a drug preparation device in the operation process of a hospital.

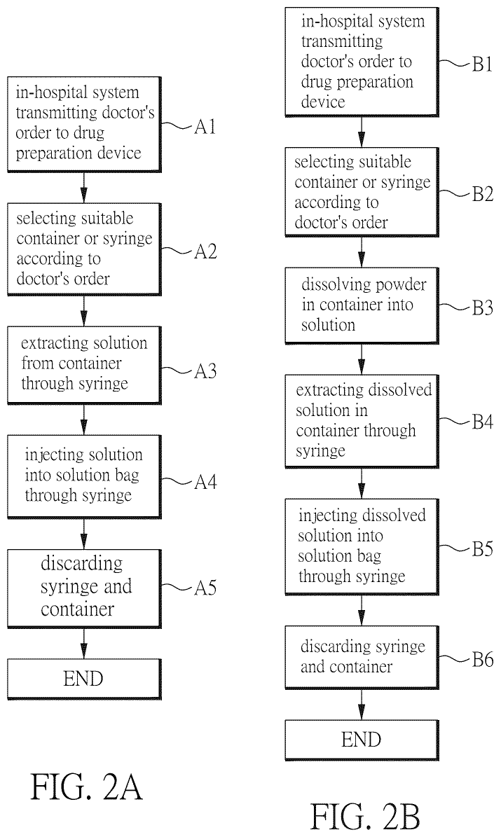

FIG. 2A is a flow chart showing the steps of the operation process of the drug preparation device according to an embodiment of the present application, and please refer to FIG. 1 at the same time. As shown in FIG. 2A, step A1 is first executed, in which the drug preparation device receives a doctor's order (for example, a prescription) transmitted by an in-hospital system of the hospital. Then, step A2 is executed, in which the operator of the drug preparation device or the drug preparation device itself (if the drug preparation device has an automated function) may select a suitable container 2 or syringe according to the doctor's order, wherein the container may contain a specific solution. Then, step A3 is executed, in which the drug preparation device may extract the solution from the container 2 through the syringe. Then, step A4 is executed, in which the drug preparation device may inject the solution into the solution bag through the syringe. Then, step A5 is executed, in which the drug preparation device discards the syringe and the container 2. In the above steps, the grasp device 1 may be used in at least one of step A2 to step A5. For example, the grasp device 1 may be used to clamp or fix the container in at least one of step A2 to step A5 so as to facilitate the proceeding of the steps, while it is not limited thereto.

FIG. 2B is a flow chart showing the steps of the operation process of a drug preparation device according to another embodiment of the present application, and please refer to FIG. 1 at the same time. As shown in FIG. 2B, step B1 is first executed, in which the drug preparation device receives a doctor's order (for example, a prescription) transmitted by an in-hospital system of the hospital. Then, step B2 is executed, in which the operator of the drug preparation device or the drug preparation device itself (if the drug preparation device has an automated function) selects a suitable container 2 or syringe according to the doctor's order, wherein the container may contain specific powder. Then, step B3 is executed, in which the operator of the drug preparation device or the drug preparation device itself (if the drug preparation device has an automated function) dissolves the powder in the container into a solution. Then, step B4 is executed, in which the drug preparation device extracts the dissolved solution in the container through the syringe. Then, step B5 is executed, in which the drug preparation device injects the dissolved solution into the solution bag through the syringe. Then, step B6 is executed, in which the drug preparation device discards the syringe and the container 2. In the above steps, the grasp device 1 may be used in at least one of step B2 to step B6. For example, the grasp device 1 may be used to clamp or fix the container in at least one of step B2 to step B6 to facilitate the proceeding of the steps, while it is not limited to this.

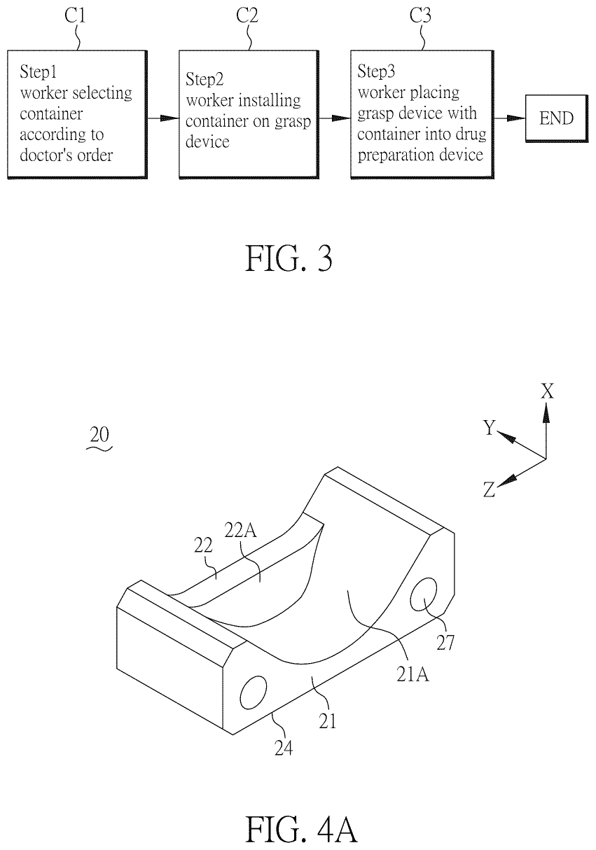

Next, the use of the grasp device 1 in the above step A2 to step A5 or step B2 to step B6 will be described. FIG. 3 is a flow chart showing the steps of clamping or fixing a container by a grasp device 1 according to an embodiment of the present application, and please refer to FIG. 1 to FIG. 2B at the same time. As shown in FIG. 3, step C1 is first executed, and a worker (for example, an operator of a drug preparation device) or an automated device (for example, a drug preparation device with automated functions) selects a container 2 according to a doctor's order. Then, step C2 is executed, in which a worker or an automated device installs the container 2 on the grasp device 1. Then C3 is executed, in which a worker or an automated device places the grasp device 1 with the container 2 into a specific position of the automated device (for example, a drug preparation device). As a result, the usage of the grasp device 1 can be understood.

One of the features of the present application is that, through the design of the mechanism and/or component structure, the grasp device 1 may be used to grasp containers 2 of different sizes, thereby solving the problems of the prior art. Next, the details of the structure of each component of the grasp device 1 will be described, and please refer to FIG. 1 again.

First, the main body 10 will be described. In one embodiment, the main body 10 may have a bottom portion 11 and a side wall portion 12, wherein the side wall portion 12 is disposed on the bottom portion 11. The side wall portion 12 may surround the bottom portion 11 to form at least a portion of the accommodation space 13. The accommodation space 13 may be used to accommodate the first structure member 20 and at least a portion of the moving member 30. In one embodiment, the side wall portion 12 may have an opening 121. The opening 121 may be oriented toward the X direction, for example, while it is not limited thereto. In addition, when the moving member 30 is placed in the accommodation space 13, a portion of the moving member 30 may pass through the opening 121 to be outside the accommodation space 13.

Furthermore, in one embodiment, the bottom 11 may also have a first perforation 14, and the extension direction of the first perforation 14 may be, for example, towards the Y direction. In addition, a convex block 15 may be disposed on the bottom portion 11. In one embodiment, the side wall portion 12 may further include a set of side wall extension portions 122 disposed opposite to each other at two sides of the opening 121 and extending outwardly away from each other in the Z direction, for example, but it is not limited thereto. In one embodiment, a side wall convex block 123 may be disposed below each side wall extension portion 122, wherein the side wall convex block 123 and the side wall extension portion 122 may form a groove 16, and the groove 16 may be used to allow the grasp device 1 to be combined or engaged with other mechanisms. For example, the groove 16 may be used for a robotic arm to perform grasping, or may be engaged with other machines (such as a liquid mixing machine), but it is not limited thereto. Furthermore, in one embodiment, the main body 10 may be provided with one or more fixing holes. For example, at least one fixing hole 17 may be provided on the bottom portion 11. The extending direction of the fixing hole 17 on the bottom portion 11 may be, for example, toward the Y direction. In one embodiment, at least one fixing hole 17 may be disposed on one side 12s of the side wall portion 12. The fixing hole 17 on the side 12s of the side wall portion 12 may extend in a direction toward the X direction, for example. In one embodiment, at least one fixing hole 17 may be disposed on the side wall extension portion 122, and the fixing hole 17 on the side wall extension portion 122 may extend in a direction toward the Y direction, for example.

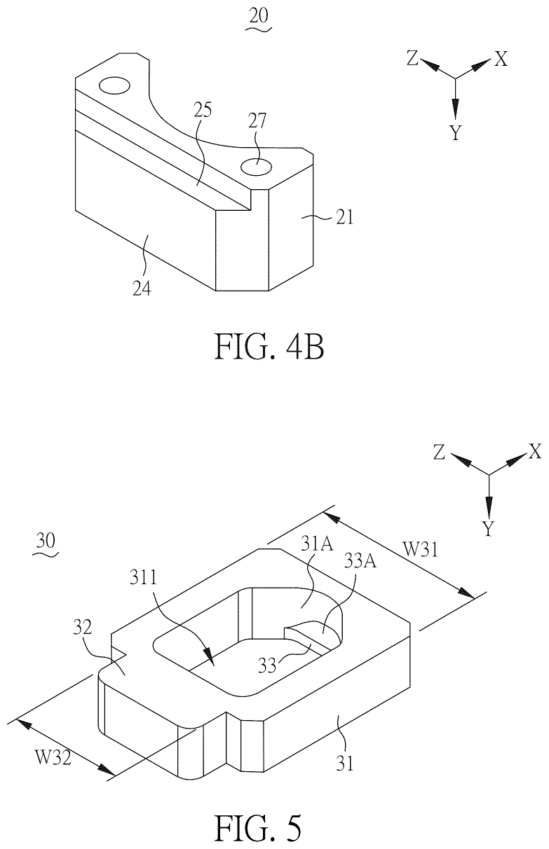

Next, the first structure member 20 will be described, and please refer to FIG. 1, 4A and FIG. 4B at the same time. FIG. 4A is a schematic diagram of a first structure member 20 according to an embodiment of the present application at one viewing angle, and FIG. 4B is a schematic diagram of a first structure member 20 according to an embodiment of the present application at another viewing angle.

As shown in FIG. 1, FIG. 4A and FIG. 4B, in one embodiment, the first structure member 20 may have at least one fixing hole 27. The extending direction of the fixing hole 27 may be, for example, toward the Y direction, and the position of the fixing hole 27 may correspond to the position of the fixing hole 17 on the bottom portion 11 of the main body 10, so that the first structure member 20 may be fixed on the bottom portion 11 of the main body 10. In one embodiment, the fixing hole 27 of the first structure member 20 and the fixing hole 17 on the bottom portion 11 of the main body 10 may be fixed together through a fixing member 70, wherein the fixing member 70 may be, for example, a screw, a different type of fixing component or a cylindrical engagement component, but it is not limited thereto.

Furthermore, in one embodiment, the first structure member 20 may have a main block 21, and the main block 21 may have a first inclined surface 21A. The first inclined surface 21A may be, for example, a concave surface and have a curvature, but it is not limited thereto. In one embodiment, the first structure member 21 may further include a stopper 22, and the stopper 22 may be disposed on the first inclined surface 21A. The stopper 22 may have a second inclined surface 22A. In one embodiment, the normal direction on the second inclined surface 22A may be different from the normal direction of one point on the first inclined surface 21A, but it is not limited thereto. The first inclined surface 21A and the second inclined surface 22A may be used to contact different portions of the container 2, respectively, but it is not limited thereto.

In addition, the first structure member 20 has a side portion 24, and the normal direction of the side portion 24 may correspond to the X direction, for example. In one embodiment, the side portion 24 may have a groove 25. The shape or size of the groove 25 may correspond to the shape or size of the convex block 15 on the bottom portion 11 of the main body 10. Therefore, when the first structure member 20 is fixed to the bottom portion 11 of the main body 10, and when viewed along the Y direction, that is, when viewed from above the grasp device 1, the first structure member 20 may overlap with the convex block 15, and the groove 25 of the first structure member 20 may match with the convex block 15, so that the first structure member 20 is engaged with the convex block 15, or the convex block 15 may provide a position limiting function for the first structure member 20.

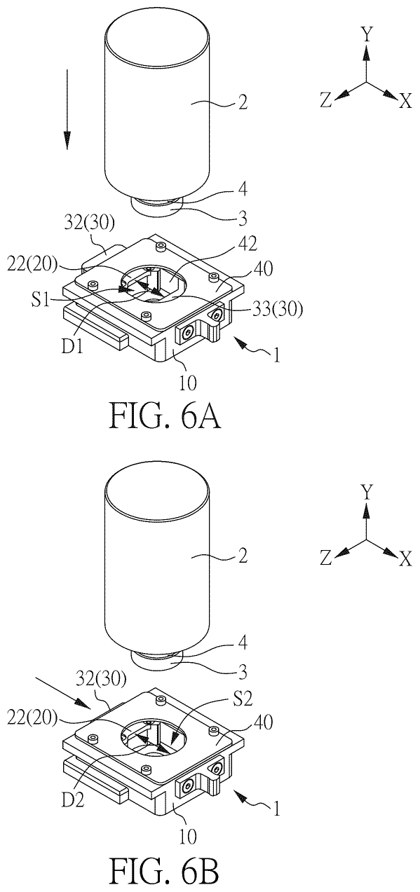

Next, the moving member 30 will be described. FIG. 5 is a schematic diagram of a moving member 30 according to an embodiment of the present application, and please refer to FIG. 1 to FIG. 4B at the same time.

As shown in FIG. 5, the moving member 30 may include a body portion 31 and a protruding portion 32, wherein the protruding portion 32 is connected to the body portion 31. The protruding portion 32 and the body portion 31 may be integrally formed, but the present application is not limited thereto. In one embodiment, the body portion 31 has an opening area 311. When the moving member 30 is disposed on the main body 10, the opening area 311 may be oriented toward the Y direction, for example. The size of the opening area 311 may be larger than that of the first structure member 20. Therefore, when the first structure member 20 and the moving member 30 are disposed on the main body 10 at the same time, the first structure member 20 may be located in the opening area 311 of the moving member 30.

The protruding portion 32 may be connected to one side of the body portion 31 and extend along the negative X direction, for example, but it is not limited thereto. In one embodiment, the protruding portion 32 may have a width W32 in the Z direction, for example, and the body portion 31 may have a width W31 in the Z direction, for example, wherein the width W32 of the protruding portion 32 is smaller than the width W31 of the body portion 31 (that is, W32<W31). Furthermore, the opening 121 of the side wall portion 12 of the main body 10 may have a width W121 in the Z direction, for example, wherein the width W121 of the opening 121 of the side wall portion 12 of the main body 10 is larger than the width W32 of the protruding portion 32 and smaller than the width W31 of the body portion 31 (that is, W32<W121<W31). Therefore, when the moving member 30 is placed in the accommodation space 13 of the main body 10, the body portion 31 may be disposed on the main body 10, a portion of the protruding portion 32 may be exposed from the main body 10, and the opening 121 of the side wall portion 12 may block the body portion 31.

In addition, in one embodiment, in the X direction, the size of the body portion 31 may be smaller than the size of the accommodation space 13 of the main body 10, so that, when the moving member 30 is placed in the accommodation space 13 of the main body 10, the moving member 30 may be movable in the accommodation space 13 along the X direction, for example, but it is not limited thereto.

In one embodiment, one side of the body portion 31 (for example, the side opposite to the protruding portion 32) may have at least one side accommodation portion 312 (shown in FIG. 1), and the side accommodation portion 312 may be used to accommodate the spring 50. Therefore, when the spring 50 is disposed in the side accommodation portion 312 of the body portion 31 and the moving member 30 is placed in the accommodation space 13 of the main body 10, a portion of the spring 50 may be located in the side accommodation portion 312 and the end portion 50a of the other portion of the spring 50 may contact an inner wall surface 12b of the side 12s of the side wall portion 12 of the main body 10 in the X direction, for example, and lean against the inner wall surface 12b of the side 12s of the side wall portion 12. The moving direction of the moving member 30 may be substantially the same as the compression direction of the spring 50. For example, when a force is applied to the protruding portion 32 of the moving member 30 along the X direction, the spring 50 may be substantially compressed along the X direction, thereby causing the moving member 30 to move in a direction substantially similar to the compression direction of the spring 50. The moving member 30 moves toward the inner wall surface 12b of the side 12s of the side wall portion 12 along the X direction, but it is not limited thereto.

In one embodiment, the inner side of the body portion 31 of the moving member 30 may have a third inclined surface 31A, wherein the third inclined surface 31A may be, for example, a concave surface and have a curvature, but it is not limited thereto. In addition, a stopper 33 may extend from the third inclined surface 31A, and extend along, for example, the negative X direction and toward the protruding portion 32. In one embodiment, the stopper 33 may have a fourth inclined surface 33A. In one embodiment, the normal direction on the fourth inclined surface 33A may be different from one of the normal directions on the third inclined surface 31A, but it is not limited thereto. The third inclined surface 31A and the fourth inclined surface 33A may be used to contact different portions of the container 2, respectively, while it is not limited thereto. In addition, when the first structure member 20 and the moving member 30 are both disposed in the accommodation space 13 of the main body 10, the stopper 22 of the first structure member 20 and the stopper 33 of the moving member 30 may be opposite to each other in the X direction, for example, while it is not limited thereto.

Next, the cover plate 40 will be described, and please refer to FIG. 1 again. In one embodiment, the cover plate 40 may have at least one fixing hole 41, wherein the fixing hole 41 of the cover plate 40 may correspond to the fixing hole 17 on the side wall extension portion 122 of the main body 10, so that the cover plate 40 may be fixed onto the side wall extension portion 122 of the main body 10. In one embodiment, the fixing hole 41 of the cover plate 40 and the fixing hole 17 on the side wall extension portion 122 of the main body 10 may be fixed together through the fixing member 70, while it is not limited thereto. The fixing method is as described above and will not be repeated here.

In addition, the cover plate 40 may also have an perforation 42. In one embodiment, the perforation 42 of the cover plate 40 may be disposed at a middle portion of the cover plate 40, for example, but it is not limited thereto. In one embodiment, the position of the perforation 42 of the cover plate 40 may at least partially overlap with the position of the opening area 311 of the body portion 31 of the moving member 30, wherein, when the cover plate 40, the moving member 30 and the first structure member 20 are all mounted on the main body 10, a portion of the first structure member 20 and a portion of the moving member 30 may be exposed in the perforation 42 of the cover plate 40, for example, a portion of the stopper 22 and a portion of the stopper 33 may be exposed in the perforation 42, and there may be a distance between the stopper 22 and the stopper 33, but it is not limited thereto. In one embodiment, the shape of the perforation 42 of the cover plate 40 may correspond to the shape of the bottle head and/or bottle neck of the container 2, such as a circle, but it is not limited thereto. In one embodiment, the size of the cover plate 40 may be larger than the size of the bottle head of the container 2, but it is not limited thereto.

Next, the engaging member 60 will be described, and please refer to FIG. 1 again. In one embodiment, the engaging member 60 may have at least one fixing hole 61. The fixing hole 61 of the engaging member 60 may correspond to the fixing hole 17 on the side 12s of the side wall portion 12 of the main body 10, so that the engaging member 60 may be fixed to the side wall portion 12 of the main body 10 through the fixing member 70, but it is not limited thereto. The fixing method is as described above and will not be repeated here. In one embodiment, the engaging member 60 may be, for example, a door buckle, which may be used to engage and fix with other mechanisms, but it is not limited thereto.

Next, the use process of the grasp device 1 will be described, and please refer to FIG. 6A and FIG. 6B, as well as FIG. 1 to FIG. 5. FIG. 6A is a schematic diagram of a first state of the grasp device 1 according to an embodiment of the present application, which is used to illustrate a situation where no force is applied to the moving member 30. FIG. 6B is a schematic diagram of the second state of the grasp device 1 according to an embodiment of the present application, which is used to illustrate the situation of applying force to the moving member 30. It should be noted that, in FIG. 6A and FIG. 6B, the grasp device 1 is in an assembled state. The grasp device 1 may be used to grasp a container 2, wherein the container 2 is exemplified by a medicine bottle, but it is not limited thereto.

As shown in FIG. 6A, when no force is applied to the moving member 30, the moving member 30 may be disposed at a first position in the X direction, for example. At this moment, a portion of the stopper 33 of the moving member 30 may be exposed in the perforation 42 of the cover plate 40, and a portion of the stopper 22 of the first structure member 20 may be exposed in the perforation 42 of the cover plate 40. In the perforation 42, there is a first distance D1 between the portion of the stopper 33 exposed to the cover plate 40 and the portion of the stopper 22 exposed to the cover plate 40. The first distance D1 may also be regarded as the shortest distance between the stopper 22 and the stopper 22, while it is not limited thereto. As a result, a portion of the accommodation space 13 may overlap with the perforation 42, so that there is a first space S1 defined between the moving member 30 and the first structure member 20. At this moment, the size of the bottle head 3 of the container 2 is larger than the size of the first space S1, so that the bottle head 3 of the container 2 cannot be put into the first space S1 through the perforation 42 of the cover plate 40.

As shown in FIG. 6B, when force is applied to the moving member 30, the spring 50 (shown in FIG. 1) may be compressed in the X direction, for example, and the moving member 30 may move, for example, in the X direction along the force direction. The moving member 30 may be disposed at a second position in the X direction, for example. In a top view direction, the area or volume of the protruding portion 32 exposed outside the main body 10 when it is at the second position is smaller than that of the protruding portion 32 exposed outside the main body 10 when it is at the first position. At this moment, a portion of the stopper 33 of the moving member 30 may be exposed in the perforation 42 of the cover plate 40, and a portion of the stopper 22 of the first structure member 20 may be exposed in the perforation 42 of the cover plate 40. There is a second distance D2 between the portion of the stopper 33 exposed in the perforation 42 and the portion of the stopper 22 exposed in the perforation 42, so that there is a second space S2 between the moving member 30 and the first structure member 20, wherein the second distance D2 is larger than the first distance D1 (that is, D2>D1), and the size of the second space S2 is larger than the size of the first space S1 (that is, S2>S1). At this moment, the size of the bottle head 3 of the container 2 is smaller than the size of the second space S2, so that the bottle head 3 of the container 2 may be put into the second space S2 through the perforation 42 of the cover plate 40. In some embodiments, in the second space S2, there may be a distance between the first structure member 20 and the bottle head 3 of the container 2, but it is not limited thereto. In some embodiments, in the second space S2, there may be a distance between the moving member 30 and the bottle head 3 of the container 2, but it is not limited thereto. In some embodiments, the first space S1 and the second space S2 may be, for example, viewed in terms of volume, or in terms of area observed in a top view of the grasp device 1, but it is not limited thereto.

In one embodiment, the size of the second distance D2 may be between 17 and 23 millimeters (that is, 17 mm≤D2≤23 mm), but it is not limited thereto. In one embodiment, the second distance D2 may be between 17.5 and 22.5 millimeters (that is, 17.5 mm≤D2≤22.5 mm), but it is not limited thereto. In one embodiment, the second distance D2 may be between 17.8 and 21.6 millimeters (that is, 17.8 mm≤D2≤21.6 mm), but it is not limited thereto. It can be seen that the grasp device 1 may be applied to containers 2 of various sizes (such as medicine bottles, but it is not limited thereto).

Furthermore, when the bottle head 3 of the container 2 is placed in the second space S2, the force applied to the moving member 30 may be stopped so that the spring 50 is released from the compressed state. At this moment, the moving member 30 moves from the second position to the first position, but the moving member 30 does not completely return to the first position because of the obstruction of the container 2. At this moment, the first structure member 20 and the moving member 30 may be stuck with the bottle neck 4 of the container 2. Therefore, the grasp device 1 may clamp or fix the container 2. In addition, when the container 2 needs to be removed from the grasp device 1, it only needs to apply force to the protruding portion 32 again to increase the space between the first structure member 20 and the moving member 30, so as to easily remove the container 2.

Next, the detailed features of the grasp device 1 when grasping the container 2 will be described in more detail, and please refer to FIG. 7A to FIG. 7C, as well as to FIG. 1 to FIG. 6B. FIG. 7A is a schematic diagram of a third state of the grasp device 1 according to an embodiment of the present application, which is used to show the situation when the grasp device 1 grasps the container 2. FIG. 7B is a cross-sectional view of the grasp device 1 taken along line AA′ in FIG. 7A. FIG. 7C is a cross-sectional view of the grasp device 1 taken along line CC′ in FIG. 7B.

As shown in FIG. 7A, when the grasp device 1 grasps the container 2, the grasp device 1 and the container 2 may be combined together in the Y direction, for example, but it is not limited thereto.

As shown in FIG. 7B, from the cross-sectional view taken along line AA′, when the spring 50 is released from the compressed state, the spring 50 provides a restoring force in the negative X direction, for example, and the restoring force may push the moving member 30 to move toward the negative X direction, so as to enable the moving member 30 to contact and squeeze one side (for example, the right side in the figure) of the bottle neck 4 of the container 2, while the other side (for example, the left side in the figure) of the bottle neck 4 may contact the first structure member 20 and lean against the first structure member 20, whereby the first structure member 20 may limit the container 2 from continuing to move toward the negative X direction, and then the container 2 may be grasped by the grasp device 1. In one embodiment, when the grasp device 1 grasps the container 2, the third inclined surface 31A of the moving member 30 may contact the side wall of the bottle neck 4 of the container 2, and the first inclined surface 31A of the first structure member 20 may contact the side wall of the bottle neck 4 of the container 2. The inclined surface 21A may contact the side wall of the other side of the bottle neck 4 of the container 2, so that the moving member 30 and the first structure member 20 may limit the movement of the container 2 in the X direction, while it is not limited thereto.

As shown in FIG. 7C, from the cross-sectional view taken along line CC′, in one embodiment, the normal direction on the fourth inclined surface 33A of the stopper 33 of the moving member 30 may be substantially mirrored with the normal direction on the second inclined surface 22A of the stopper 22 of the first structure member 20 relative to the top view direction (that is, Y direction) of the grasp device 1, but it is not limited thereto. In one embodiment, when the grasp device 1 grasps the container 2, the fourth inclined surface 33A of the moving member 30 may contact the lower edge 3b of the bottle head 3 of the container 2, and the second inclined surface 22A of the first structure member 20 may contact the lower edge 3b of the bottle head 3 of the container 2, whereby the moving member 30 and the first structure member 20 may limit the movement of the container 2 in the Y direction, but it is not limited thereto.

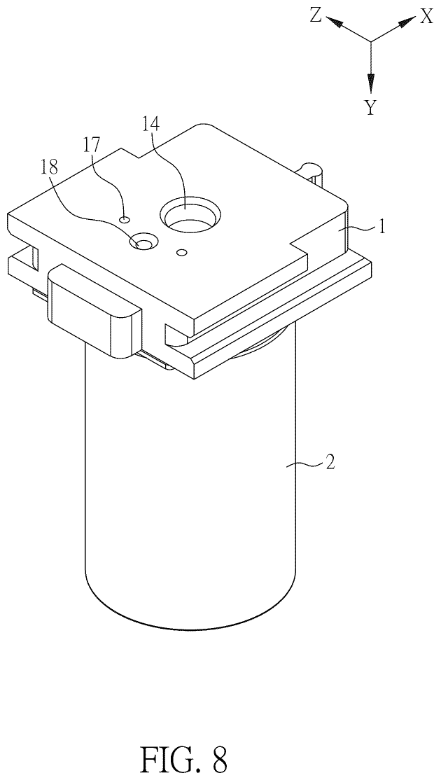

The grasp device 1 of the present application may also have more features. FIG. 8 is a schematic diagram of the third state of the grasp device 1 according to an embodiment of the present application at another viewing angle, and please refer to FIG. 1 to FIG. 7C at the same time.

As shown in FIG. 8, in one embodiment, the bottom portion 11 of the main body 10 of the grasp device 1 may have a first perforation 14. The first perforation 14 may be, for example, an extraction hole, through which the needle of a syringe may be inserted into the container 2 to extract the solution in the container 2, while it is not limited thereto. In addition, the first perforation 14 may also be used as a positioning hole for engaging the grasp device 1 with other mechanisms, while it is not limited thereto. In one embodiment, the bottom portion 11 of the main body 10 of the grasp device 1 may have a second perforation 18. The second perforation 18 may be, for example, a positioning hole for engaging the grasp device 1 with other mechanisms, while it is not limited thereto. In one embodiment, the size of the second perforation 18 may be smaller than the size of the first perforation 14, while it is not limited thereto. In one embodiment, the grasp device 1 is engaged with other mechanisms by means of the first perforation 14 and the second perforation 18, thereby reducing the problem of rotation generated between the grasp device 1 and other mechanisms so as to improve the positioning accuracy.

It can be seen from this that the grasp device 1 of the present application may be applicable to containers 2 of various sizes, or the structure of the grasp device 1 is simple and the manufacturing cost may be reduced, thereby solving the problems of the prior art.

Thus, the detailed features of the grasp device 1 of the present application can be understood. It should be noted that the numerical values or dimensions, the outlines and structures of the components mentioned in the above description are merely examples, and the present application is not limited thereto.

In one embodiment, the present disclosure may determine whether a product in contention falls within the protection scope of the present disclosure at least by the presence or absence of components, component configurations, mechanism observation and/or operating modes of the product to determine whether it falls within the protection scope of the present disclosure, while it is not limited thereto.

The details or features of the various embodiments of the present disclosure may be mixed and matched as long as they do not violate the spirit of the invention or conflict with each other.

The aforementioned specific embodiments should be interpreted as merely illustrative, and not limiting the rest of the present application in any way, and the features of different embodiments may be mixed and matched as long as they do not conflict with each other.

1. A grasp device for grasping a container, comprising:
a main body;
a first structure member fixed to the main body; and
a moving member disposed on the main body, wherein the first structure member and the moving member are used to contact a portion of the container, wherein there is a first space between the moving member and the first structure member when the moving member is disposed at a first position, and there is a second space between the moving member and the first structure member when the moving member is disposed at a second position, where a size of the second space is larger than a size of the first space.

2. The grasp device as claimed in claim 1, wherein the first structure member has an inclined surface, and the inclined surface of the first structure member is used to contact the container.

3. The grasp device as claimed in claim 1, wherein the moving member has an inclined surface, and the inclined surface of the moving member is used to contact the container.

4. The grasp device as claimed in claim 1, further comprising an engaging member fixed to the main body.

5. The grasp device as claimed in claim 1, wherein the first structure member has a first stopper, the moving member has a second stopper, and there is a distance between the first stopper and the second stopper.

6. The grasp device as claimed in claim 5, further comprising a cover plate, which is disposed on the main body and has a perforation.

7. The grasp device as claimed in claim 6, wherein the perforation of the cover plate exposes a portion of the first stopper and a portion of the second stopper.

8. The grasp device as claimed in claim 5, wherein there is a first distance between the first stopper and the second stopper when the moving member is at the first position, and there is a second distance between the first stopper and the second stopper when the moving member is at the second position, where the first distance is smaller than the second distance.

9. The grasp device as claimed in claim 1, wherein the main body has a first perforation, and the first perforation is an extraction hole or a positioning hole.

10. The grasp device as claimed in claim 9, wherein the main body has a second opening, wherein the size of the second opening is smaller than the size of the first perforation, and the second perforation is a positioning hole.

11. The grasp device as claimed in claim 1, further comprising at least one spring, wherein a portion of the at least one spring is disposed in the moving member, and another portion of the at least one spring is exposed outside the moving member and in contact with the main body.

12. The grasp device as claimed in claim 11, wherein the moving member has at least one side accommodation portion for accommodating the at least one spring.

13. The grasp device as claimed in claim 6, wherein an accommodation space is formed between the cover plate and the main body for accommodating the first structure member and at least a portion of the moving member, the main body has a bottom portion and a side wall portion, the side wall portion is disposed on the bottom portion and surrounds the bottom portion to form at least a portion of the accommodation space.

14. The grasp device as claimed in claim 13, wherein the side wall portion has an opening and, when the moving member is placed in the accommodation space, a portion of the moving member is outside the accommodation space through the opening.

15. The grasp device as claimed in claim 14, wherein the side wall portion further including a set of side wall extension portions arranged opposite to each other on two sides of the opening.

16. The grasp device as claimed in claim 15, wherein a side wall convex block is disposed below each of the side wall extension portions, and the side wall convex block and the side wall extension portion form a groove.

17. The grasp device as claimed in claim 13, wherein a convex block is provided on the bottom portion of the main body, the first structure member has a side portion, the side portion has a groove, and the groove matches with the convex block.

18. The grasp device as claimed in claim 13, wherein the moving member has a body portion and a protruding portion, the protruding portion is connected to the body portion 1, the body portion has an opening area, and a size of the opening area is larger than a size of the first structure member.

19. The grasp device as claimed in claim 18, wherein the protruding portion has a first width, and the body portion has a second width, where the first width is smaller than the second width.

20. The grasp device as claimed in claim 19, wherein the opening of the side wall portion of the main body has a third width, which is larger than the first width and smaller than the second width.
